(19) United States
(12) Patent Application Publication
(10) Pub. No.: US 2015/0058238 A1
(43) Pub. Date: Feb. 26, 2015

(54) Social Polling Functions And Services

(71) Applicant: Donald Milley, Wyncote, PA (US)

(72) Inventors: Donald E. Milley, Wyncote, PA (US); Shibani Chavan, Mumbai-42 (IN); Sumit Ghosh, Chattisgarh (IN)

(21) Appl. No.: 14/315,284

(22) Filed: Jun. 25, 2014

Related U.S. Application Data
(60) Provisional application No. 61/839,177, filed on Jun. 25, 2013.

(51) Int. Cl. G06Q 50/00; H04L 29/08

(52) U.S. Cl. CPC G06Q 50/01; H04L 67/10
USPC 705/319

(57) ABSTRACT

A system for polling people connected to a network includes an end user electronic device connected to another electronic device via a network. A user enters a survey question into the end user's device and submits it to the another electronic device via the network. The another electronic device receives the survey question and displays it. In response to an answer given to the poll question on the another electronic device, the another electronic device submits the answer to the end user electronic device via the network.

### BACKGROUND

The present invention is in the field of websites and mobile smartphone applications, though other communication services are also utilized.

The increasing prevalence of online social networks and other communication tools has enabled people to communicate more, and more frequently. The ability to ask each other questions is often awkward or limited in scope. Users often cannot ask differing groups of people, post multiple photos, use multiple services and communication methods, or interface with third party sites.

### SUMMARY OF THE EMBODIMENTS

The invention is multi-featured software and/or service that allows users to ask other questions and get quantitative and qualitative feedback. It functions via a website, mobile smartphone application, email, SMS and MMS text messaging, integration with social networks, third party websites, and other methods.

A system for polling people connected to a network includes an end user electronic device connected to another electronic device via a network. A user enters a survey question into the end user's device and submits it to the another electronic device via the network. The another electronic device receives the survey question and displays it. In response to an answer given to the poll question on the another electronic device, the another electronic device submits the answer to the end user electronic device via the network.

### BRIEF DESCRIPTION OF THE DRAWINGS

FIG. 1 is an example of the Main Feed of questions by other users.

FIG. 2 is an example screen when another user's question is selected.

FIG. 3 is an example screen when a user wants to input a yes/no question, with or without photo.

FIG. 4 is an example screen for when a user wants to input a question with multiple answers.

FIG. 5 is an example screen for a user to view previous questions he or she has answered.

FIG. 6 is an example screen of a user view of previous questions he or she has asked.

FIG. 7 is an example screen of a user profile page.

FIG. 8 is an example screen of an inline offer as a question.

FIG. 9 is an example screen of how a user would share a question in multiple ways.

FIG. 10 is an example screen of how a user would invite others in multiple ways.

FIG. 11 is an example feed of questions on a website.

FIG. 12 is an example of the button widget for asking questions from 3rd party websites.

FIG. 13 is an example of sharing a question to the service and social networks from 3rd party websites.

FIG. 14 is an example of a button widget on a 3rd party site with multiple-choice options.

FIG. 15 is an example of a multiple choice “meme” of merged photos for sharing on social networks.

FIG. 16 shows a sample email reporting the results of a survey.

### DETAILED DESCRIPTION OF THE EMBODIMENTS

The system and method herein provides a multi-platform (i.e. multiple operating systems and devices) network that enables users to use a network of computing devices, their interactive screens, cameras, microphones, and multimedia playback capabilities to survey others and use that survey information for individual users or corporate retailers. The system may operate within a mobile device software application, website, social media application, integrated button widgets on third party sites, email, text messaging, or other application.

As described here, users access the system using mobile applications for iOS, Android, Kindle Fire, Windows and other mobile or desktop platforms on their electronic devices like their PCs or mobile phones. These applications may be developed for the specific platform or device type and interface with a server or servers for presentation of the information. The servers themselves may use php, javascript, SQL databases and other tools and software to present data (typically a JSON feed, but html and other outputs are also used for both the mobile apps and other presentation mechanisms).

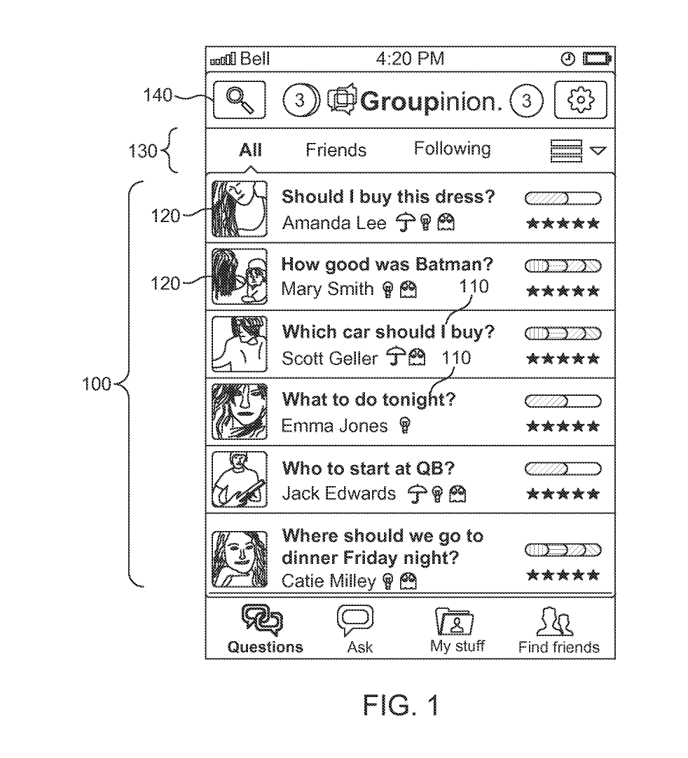

After logging in via a social network account (such as Facebook Connect) or a standalone account the end user may be presented with a questions feed 100, shown in FIG. 1, where a user can scroll up and down and browse the questions 110 that users 120 have presented. For example, the first user 120, Amanda Lee, asks the question “Should I buy this dress?” End users can apply filters using a filter bar 130 by all users, friends, following, category type of the question, and more. End users may also search using the search option 140 by multiple criteria, keyword, date, number of votes, category, user, user type and much more. A search may return the appropriate data, which might include a question, answer, or user profile.

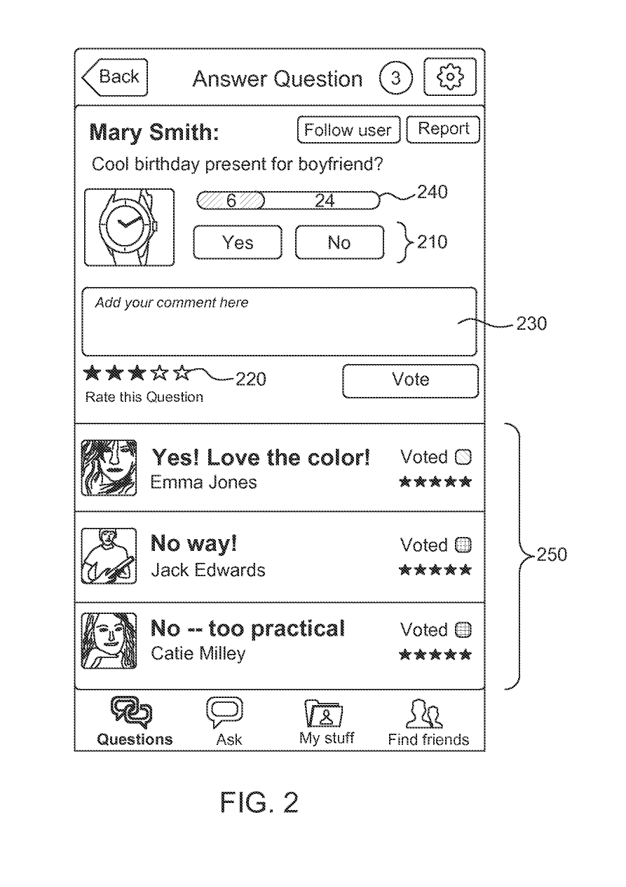

Selecting one of the questions 120 may bring up a question for viewing, voting 210 regarding answers to the question, rating 220 the content or quality of the question and user, and commenting 230 as shown in FIG. 2. A graphical vote bar 240 may show the weighted breakdown of votes, and may update dynamically with each vote cast (alternatively, the application may show an image of the choice with the most votes and/or a textual display of the vote count or %). A vote percentage, or absolute vote count, may be superimposed on this bar or displayed in other ways. The end user may make their vote selection, enter an optional comment, optionally rate the quality of the question, and this feedback 250 may be added to poll.

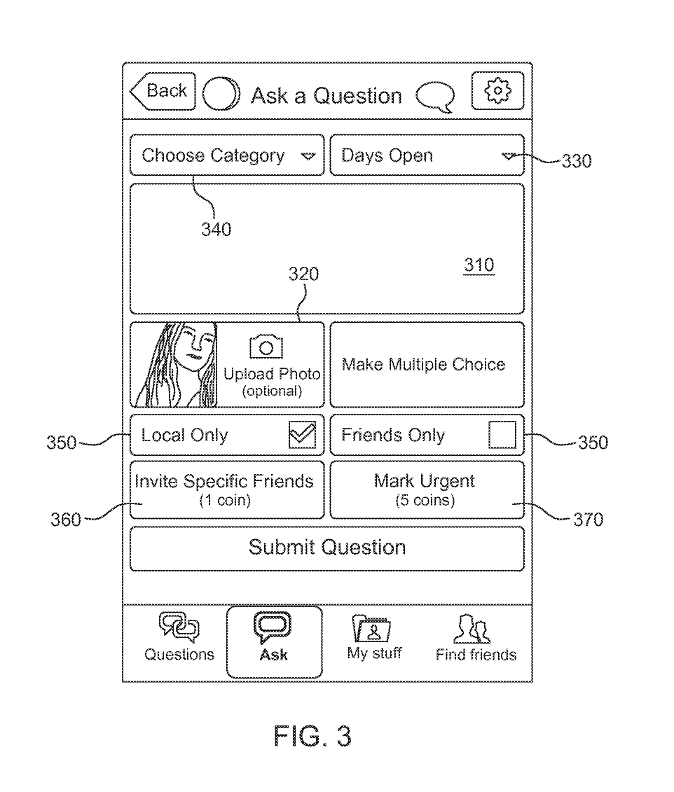

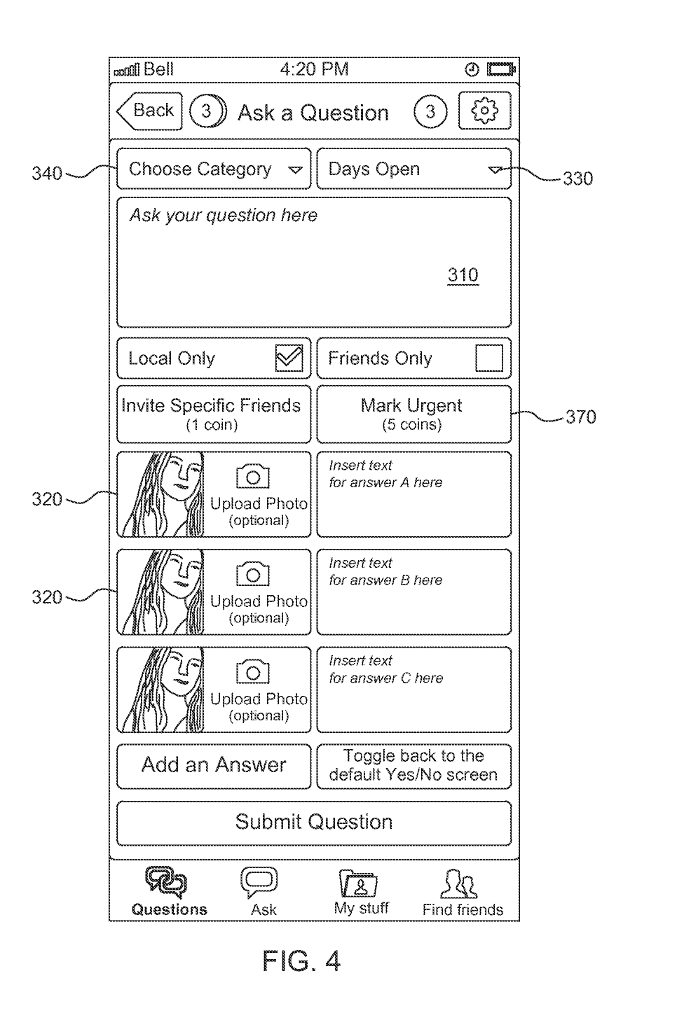

FIGS. 3 and 4 show example ways in which a question may be asked, various other options exist based on the delivery platform. That is, the interface on the website or email may look different but present similar data inputs. These may include, but are not limited to:
The question (input into area 310)
A photo, or photos 320
Captions for the photos or other answer options
Time the poll will remain active 330
Category the question pertains to, such as Entertainment or Shopping 340
Filters as to who can view the question, including but not limited to Friend status, Location, and more 350
invitations to only specific people 360
User may optionally mark the question Urgent, which may change how the question is handled or displayed 370
Additional inputs as required to define the question

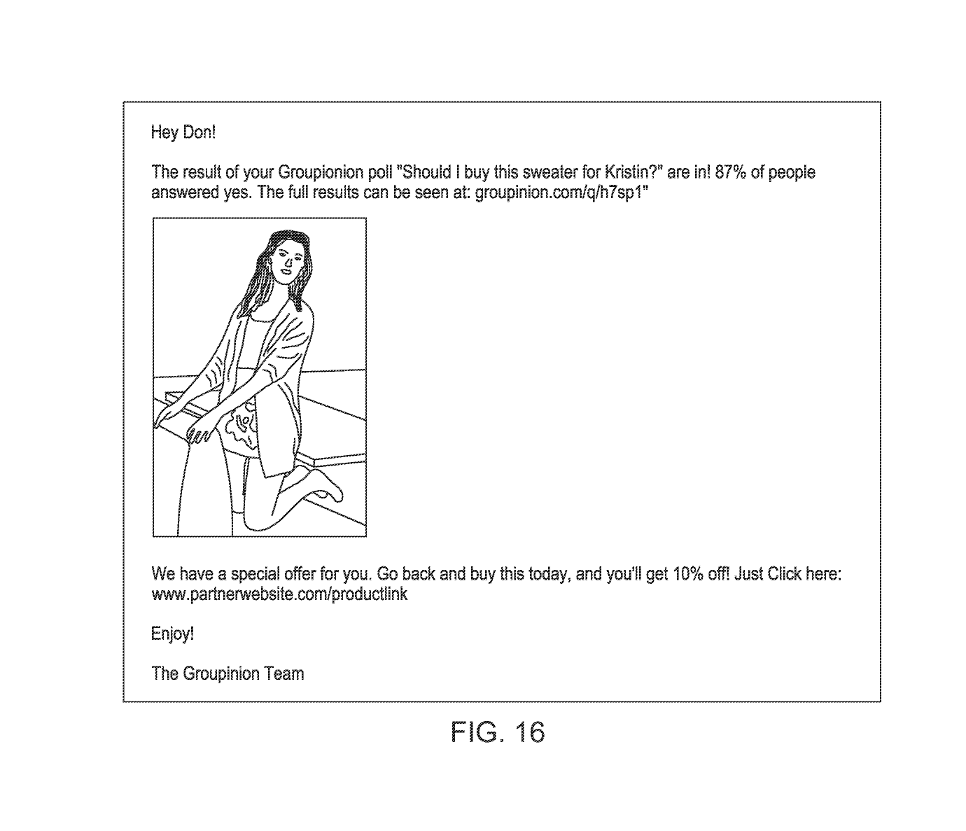

By clicking the submit question button 380, the end user's device transmits a signal across an available network so that others users can see the question on their devices and interact with the end user by submitting a response. The users may receive a notification via the network in the form of a mobile device notification, text message, email (shown in FIG. 16) or other form.

The end user can also ask questions directly to a contact list on their mobile device.

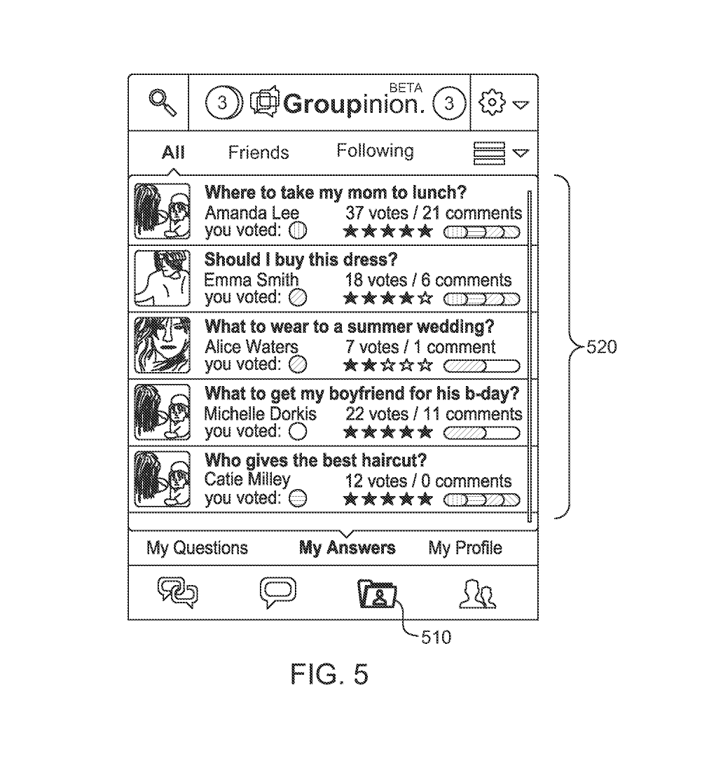

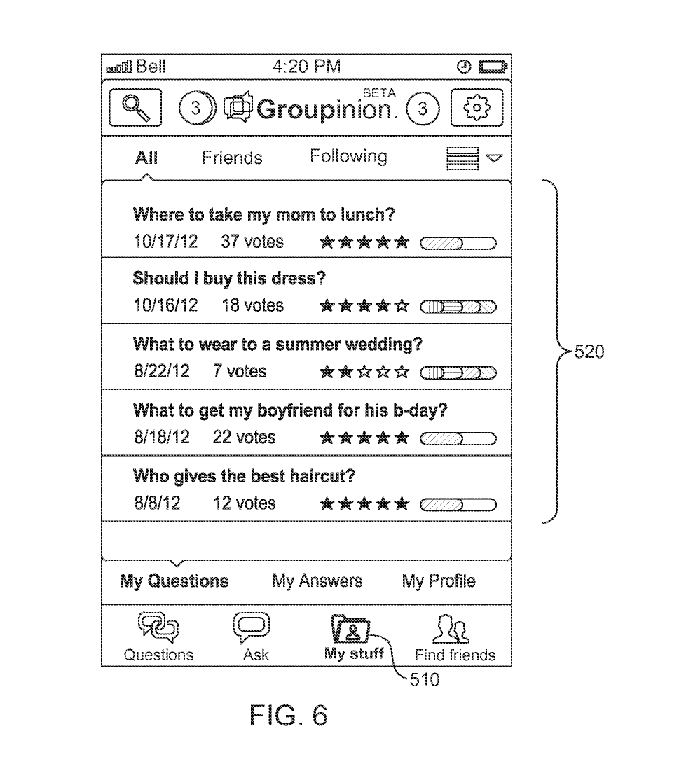

FIGS. 5 and 6 show sample displays of questions the user has asked and answered, sortable in multiple ways. The end user arrived at these screens by selecting the “My Stuff” 510 icon, which then calls up relevant summary data in a response window 520. The response data 520 may be sorted in various manners including but not limited to category and question type, expiration date, friend status and more.

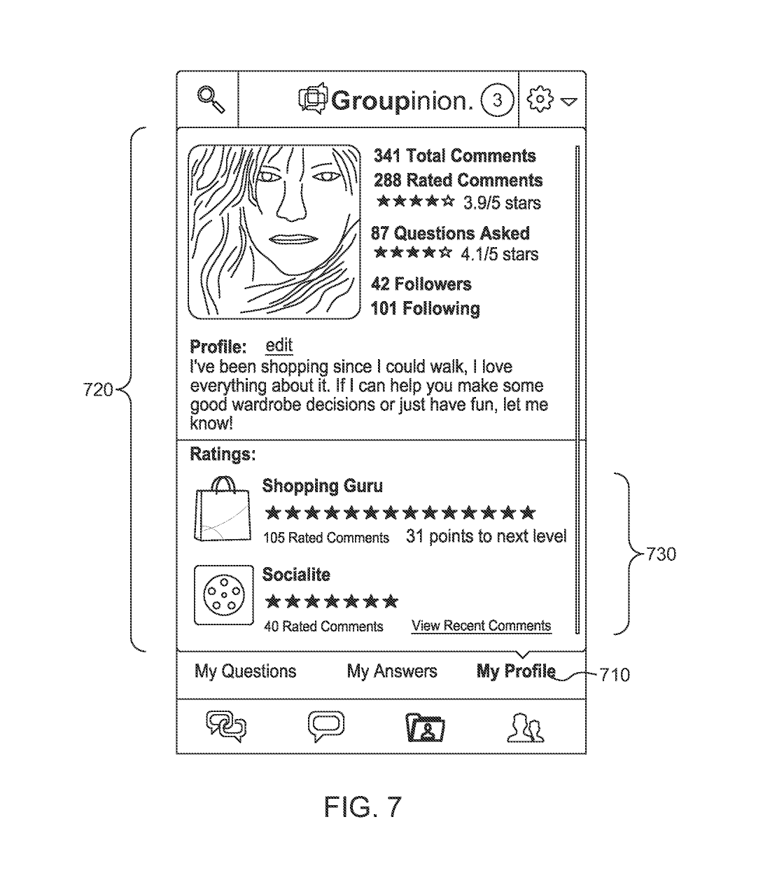

FIG. 7 shows an example of a user profile 720 arrived at when an end user selects “my profile” 710 under the my stuff 510 menu. The system may track ratings 730 in categories based on performance, including but not limited to number of questions asked and answered, quality of the questions, frequency of usage, and more.

Through a number of methods, the system may track user behavior and preferences. This includes, but is not limited to:
Linguistics, such as words mentioned in questions, comments, profile and more.
Photos
UPC and other barcodes scanned by the user (the use of barcode data with respect to social polling is particularly unique)
Website URLs and links connected to a poll

Such analysis may be done on a per-user basis or in some aggregate, including but not limited to gender, age, connection and system type and other demographic and user data.

With this data, researchers like retailers may be able to measure that women in New York aged 18-25 like red heels over sandals and men in Europe aged 39-50 with iPads like Metallica over Justin Bieber, and much more. Such data analysis is invaluable to researchers and previously could only be done through the use of surveys or analysis of purchasers. In the system described herein, the data analysis is possible by measuring people's opinions without intruding into their life with a survey or relying on their purchase history.

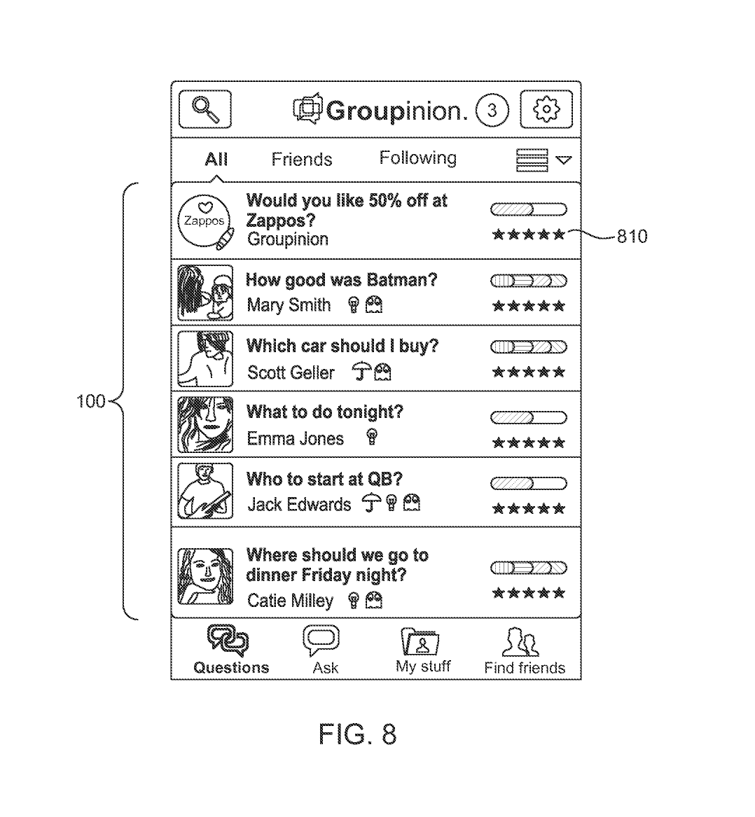

The system may also have the ability to pin questions to the top of the feed 100 or present them in different ways. This may be due to the marking of the question as urgent or some other tag. Additionally, as shown in FIG. 8, the system may insert a commerce ad/offer 810 in the form of a question. The question may be generated as the result of behavior analysis, such as an offer at a shoe retailer if the know the end user likes shoe shopping based on earlier questions, responses, and questions, or demographic end user information, but may also be generic in nature.

The user may also be notified on their mobile device of events pertaining to their use of the service through a function called push notification. This alerts their phone through a noise, vibration, or other method that an action or notification has occurred relating to their account. Alerts may include someone answering their questions, someone asking them a question, them receiving a special offer and more.

All or nearly all of this functionality is replicated on websites, applications within other websites and social networks, email and other delivery mechanisms.

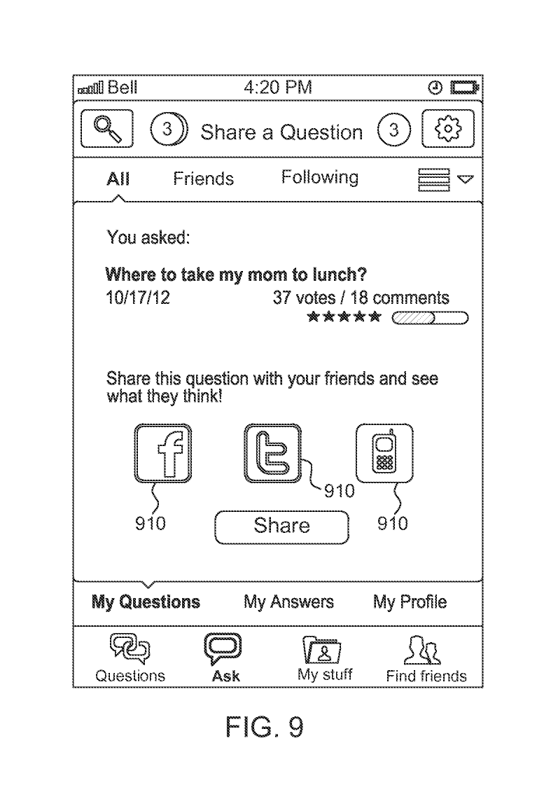

FIG. 9 shows a question sharing integration function that allows the user to publish a poll to multiple sources 910 with one click. This may be popular social networks like Twitter, Facebook, Pinterest and more, or also to the user's contact list from their phone. Emailing or SMS/MMS texting the question can also happen from this screen, depending on configuration.

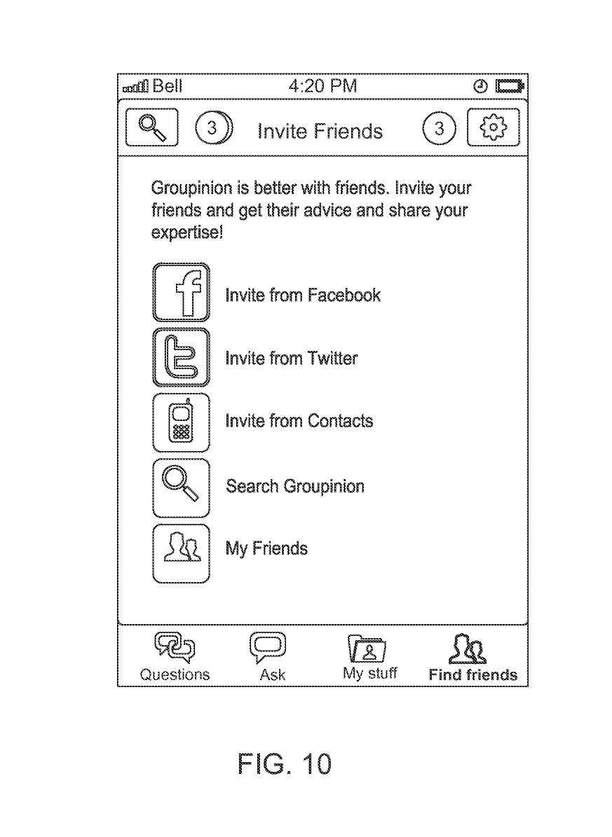

FIG. 10 shows a sample screen in which a user may directly invite others to the service, through the above services and more.

Another feature that may be desirable and available is the ability of an user to scan other surveys on specific or general topics. Thus, an end user might search for a product and see what other surveys have been completed and what the related results are. Alternatively, these search results may be posted on a product page.

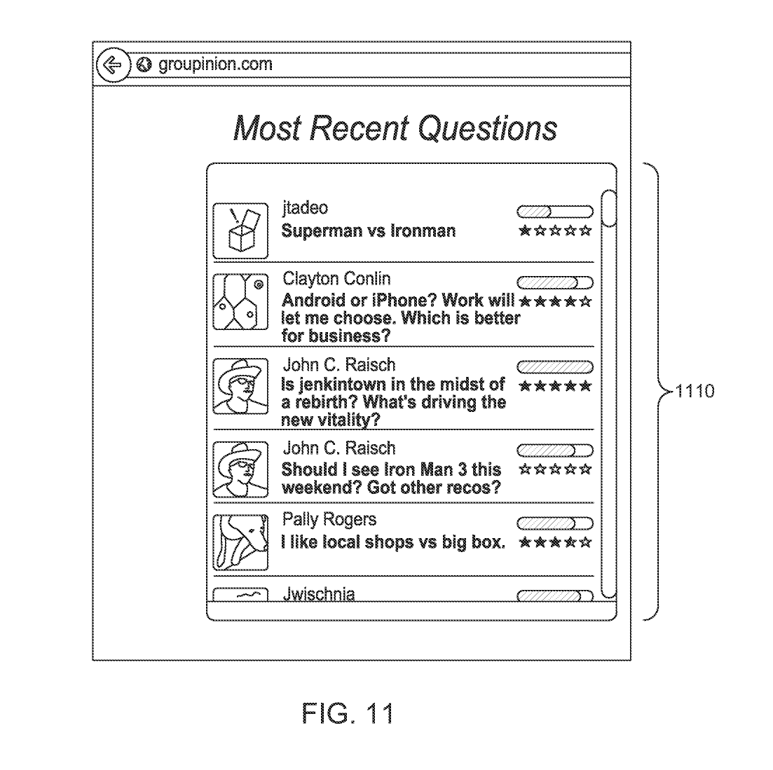

FIG. 11 shows a sample website Feed Widget 1110 that allows a website owner to show system questions on its site. The questions may be filtered based on keyword or topic that a website owner desires association with. Additionally, users, companies, and other entities may create their own “channel” on the service. A channel would function as a user-controlled category of questions. For example, a major brand can create its own channel with a store for people to ask them and other users about its products, or an individual can create a channel for her and 5 friends to ask questions about other issues.

A suite of management tools helps users manage their channels, inviting and kicking out people, setting preferences, managing content within the channel and more. There are many other uses and applications for channels of polls within this system.

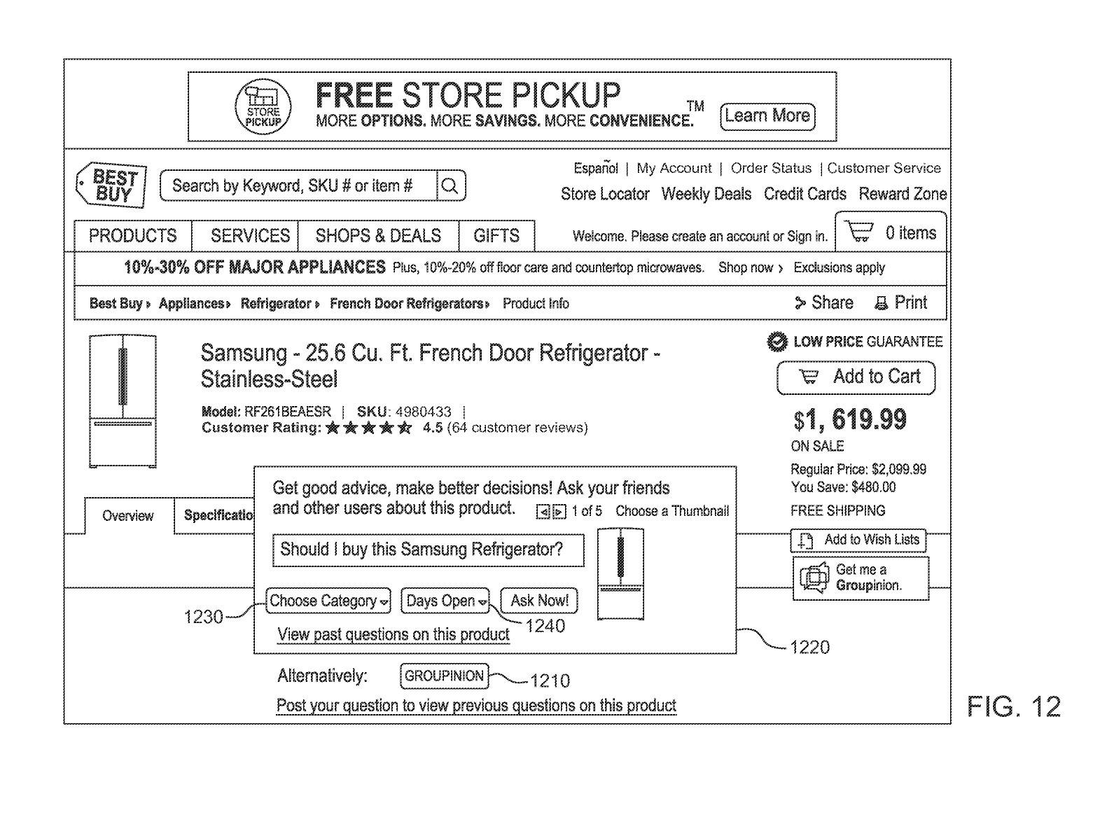

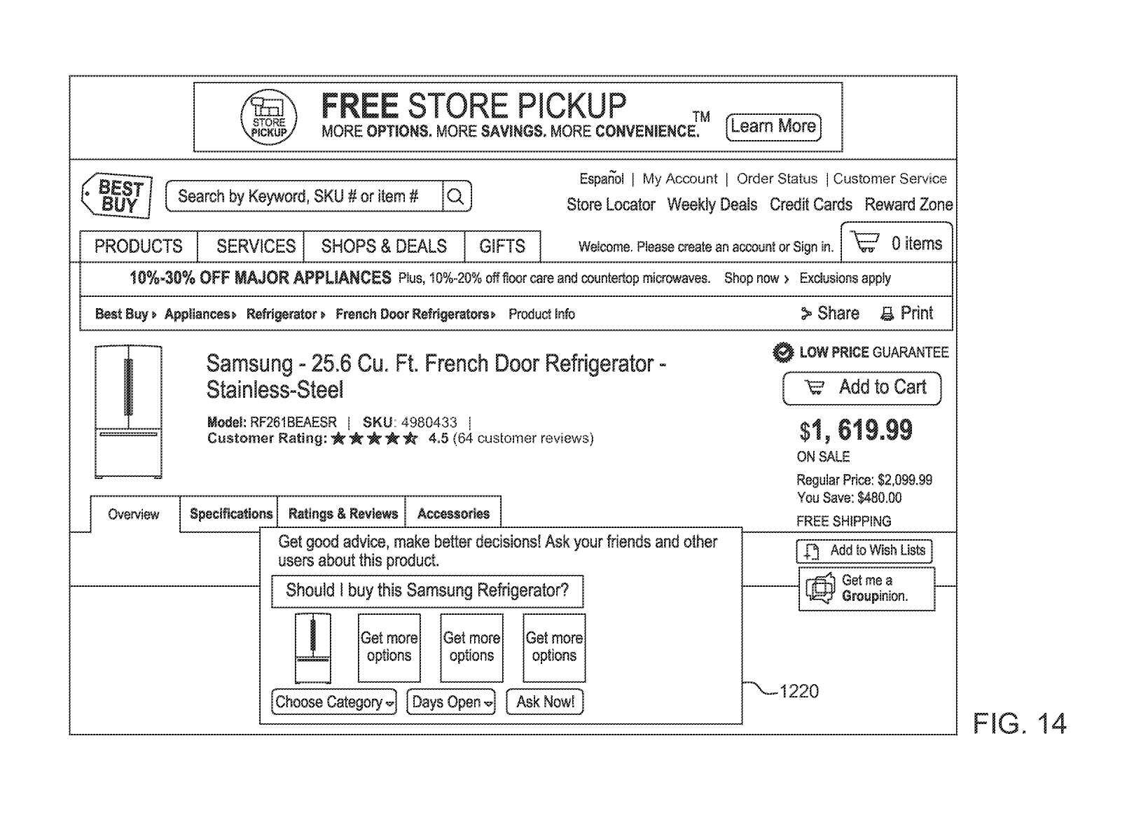

Another series of integrated functions may be available related to the ability to ask questions regarding items on a 3rd party website. These are typically items available for sale or news articles and opinions, but may include other items found on websites. These 3rd party websites embed the polling functionality, usually within a button widget window 1220 as seen in FIGS. 12-14. When a user clicks the button 1210, the system pulls data from the current page, such as relevant images, website URL, price, location, shipping costs, and more. The system analyzes this data, including but not limited to parsing available images by size, contextual importance, and other criteria, so the user only has a few images they need to sort through to properly configure their poll. Additional links off the target page may be followed to find other images for presentation in the window 1220. Specifically, larger images of products and photographs that would look better when shared. Additional data may be obtained via integration with or pulling data from, a 3rd party website's content management system.

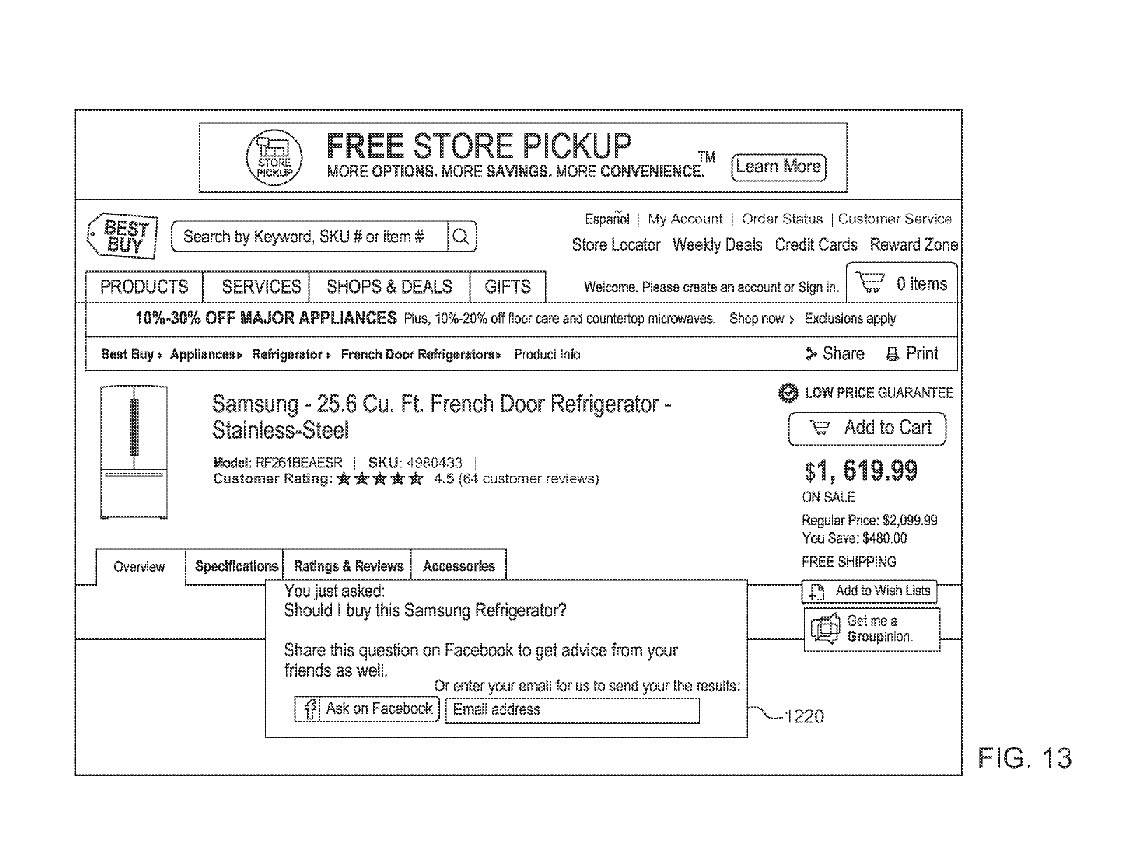

Then, either within the current page or in a new browser window, the system may allow the end user to ask about the related item, as shown in FIG. 13. Such a question may then be posted to the system for viewing in newsfeeds on mobile applications, website, email, and other media. The question can also be posted to various social networks and shared in other ways as well, including but not limited to email, text messaging, and transfer to other website feeds. Another variation to this social polling for 3rd party sites allows users to select various options in a multiple-choice scenario. For example, a user can select two or more products for comparison voting, such as “which of these three washing machines is the best?”

The retailer or another party to this transaction may capture the end user (customer) data from within the system including, but not limited to:
User demographics
Page and item data, such as the data mentioned above like name, pricing, other information
Commerce and transaction data, such as the number of people buying the item, % of people buying the item, purchase price, link used to access page/referral source
User actions on the page and throughout the site, page viewing, visitation, drop-off, and more
Voting preferences, such as product A polls better than product B or more people liked article X over article Y, some of which may be numerical in nature, but other may be contextual based on comments or other input.

In addition to capturing the data, the retailer may do many things with the captured data. For instance, in the above example, the 3rd party may use its knowledge about people's preferences and increase the price of product A since more people prefer it over B, or to display it in views before B, or to bundle product A with other products. On an individual basis, the system programmer or administrator or the 3rd party may put other products in front of the end user that are similar, related, or complimentary to the user's preferences. For example, if the system shows that Mary likes red shoes, it can show her red shoes, or even show her lots of black shoes to make the red shoes she eventually finds look better, or other ways of manipulating the data and presentation for the 3rd party retailer's goals, which likely including maximization of ecommerce profits.

Once the user has posted their question, including potentially required data like question expiration date 1240, category 1230, places to post the question, user information and more, users may be emailed, messaged, and visually notified of the posting, including links to various places to view the question, including perhaps on other websites. Upon the expiration of the poll, the user and anyone else who has answered the question is emailed, messaged and otherwise notified as to the close of the question, the results, and other data. These messages may include a link to the original product, article or other website page they were asking about. Oftentimes, this may invite them into additional action, such as buying the product, commenting or sharing an article, and more.

The system provider may have the opportunity to earn revenue through generating these actions. A limited example of this might include an end user asking if they should buy a specific TV. The end user receives the results and clicks the link on the page back to the TV and buys the TV because the results indicated they should buy it. In such a case, the system provider may be paid on a flat fee or commission basis. There are many other applications to this functionality, it is not limited to ecommerce, this is provided as an illustrative example only.

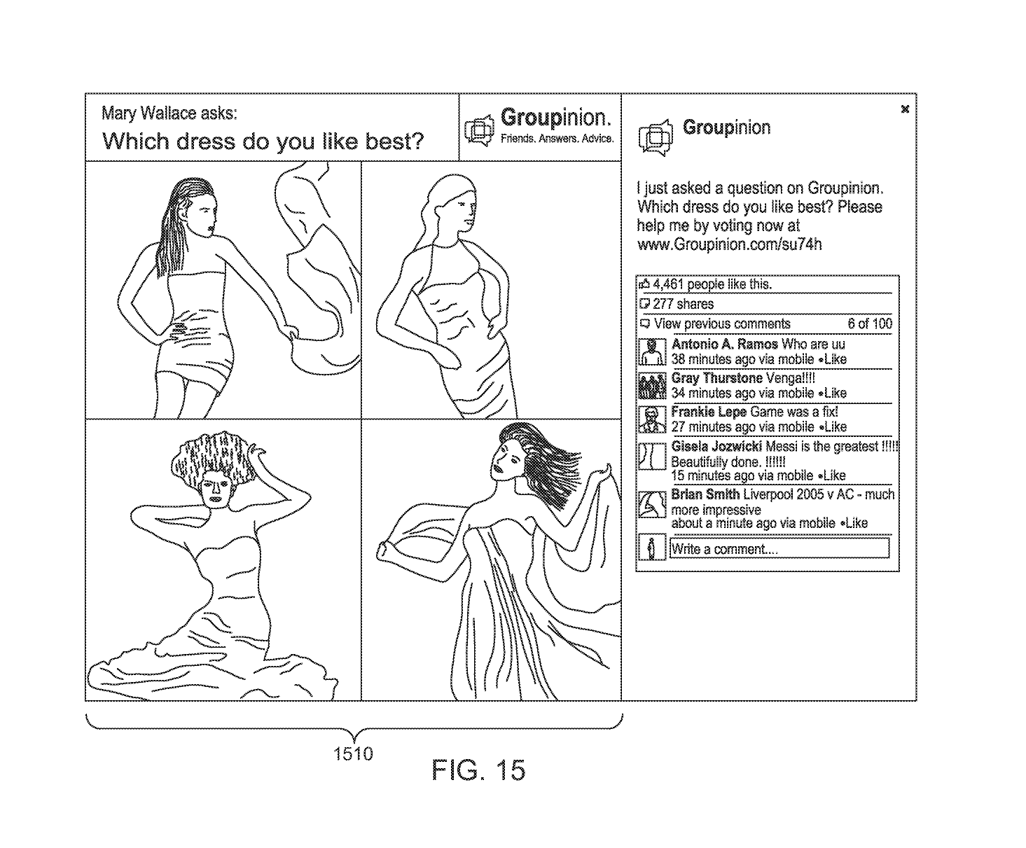

Another function of the system may be its use to generate memes 1510, as shown in FIG. 15. This function allows the end user to post a picture to websites or social networks with an associated question and polling function. While some other services may allow their users to post pictures and perhaps even allow basic questions, the current system allows the user to post the picture or pictures with a link back to a poll and get the quantitative and qualitative information described in this document. The system also may allow the user to post multiple pictures as one image. This permits greater usefulness in use of social networks and greater clarity of information on the system provider, retailer, and other websites, among other things. The posting of pictures to social networks and websites with an associated question with a link to a poll, may be particularly appealing to end users and retailers.

While the invention has been described with reference to the embodiments above, a person of ordinary skill in the art would understand that various changes or modifications may be made thereto without departing from the scope of the claims.

1. A system for polling people connected to a network comprising:
an end user electronic device into which a survey question is entered;
a network connected to the end user electronic device and another electronic device, wherein the survey question is submitted to the another electronic device via the network, wherein the another electronic device receives the poll question and displays it, wherein in response to an answer given to the survey question on the another electronic device, the another electronic device submits the answer to the end user electronic device via the network.
